(19) United States
(12) Patent Application Publication
(10) Pub. No.: US 2026/0285604 A1
(43) Pub. Date: Sep. 24, 2026

(54) TEMPERATURE CONTROL IN BATTERY PASTE APPLICATION HOPPER ASSEMBLY

(71) Applicant: Wirtz Manufacturing Company, Inc., Port Huron, MI (US)

(72) Inventors: John W. Wirtz, II, Fort Gratiot, MI (US); Michael R. Romeo, St. Clair, MI (US)

(21) Appl. No.: 19/570,477

(22) Filed: Mar. 18, 2026

Related U.S. Application Data
(60) Provisional application No. 63/773,598, filed on Mar. 18, 2025.

(51) Int. Cl. B65G 11/20; B65D 88/26; B65D 88/74; H01M 4/20; H01M 10/12

(52) U.S. Cl. CPC B65G 11/206; B65D 88/26; B65D 88/744; B65D 2588/74; B65G 2201/04; H01M 4/20; H01M 10/12

(57) ABSTRACT

A battery paste application hopper assembly and a method of temperature control of the battery paste application hopper assembly are set forth. Temperature control capabilities of electrochemically-active battery paste material held in the battery paste hopper assembly is enabled. Unlike previous battery paste hoppers, one or more walls of the battery paste hopper assembly can be actively heated or cooled, as desired, in order to transfer heating or cooling to the battery paste material. Enhanced rheological properties of the battery paste material are therefore effected. Greater uniformity, consistency, and flowability of the battery paste material can be maintained while held in the battery paste hopper assembly with use of the temperature control capabilities described herein.

### CROSS-REFERENCE TO RELATED APPLICATION

This patent application claims the benefit of U.S. Provisional Patent Application No. 63/773,598, with a filing date of Mar. 18, 2025, the contents of which are hereby incorporated by reference in their entirety.

### TECHNICAL FIELD

This disclosure relates generally to equipment for battery component manufacture and, more particularly, to battery paste material application machines and hoppers equipped therein.

### BACKGROUND

Lead-acid batteries are a common source of electrical energy and are often used as automotive batteries, aeronautic batteries, marine batteries, consumer equipment batteries, small engine batteries, industrial batteries, as well as other mobile and stationary applications. Certain types of lead-acid batteries include numerous positive and negative plates made of lead-based alloy metal grids with an electrochemically-active battery paste material applied thereon. The grids serve as the current conductor or collector of the established electrode, and the paste material serves as the active electrochemical material of the electrode.

Somewhat early in manufacture, the grids are usually supplied in a continuous strip of individual cast grids connected together, or made as individual cast grids. In the case of the strip of individual cast grids, the strip travels through a pasting machine and beneath a hopper where the battery paste material is applied to the grids. Battery paste hoppers hold a supply of battery paste material and steadily dispense sufficient amounts of the material to the strip of grids passing below. Rollers and paddles at an interior of battery paste hoppers and submerged in the battery paste material keep the material mixing and moving in the hoppers and incite dispensation of the battery paste material. An example of a pasting machine is described in U.S. Patent No. 9,437,867, assigned to Wirtz Manufacturing Company, Inc.

### SUMMARY

In an embodiment, a battery paste application hopper assembly may include a housing that has at least one wall that at least partly establishes an interior for holding electrochemically-active battery paste material therein amid use of the battery paste application hopper assembly. At least one fluid-flow passage resides in the at least one wall, and a heating and/or cooling fluid circulates through the at least one fluid-flow passage amid use of the battery paste application hopper assembly.

In an embodiment, a method of temperature control of a battery paste application hopper assembly may involve a multitude of steps. One step may involve providing at least one fluid-flow passage in at least one wall of a housing of the battery paste application hopper assembly. Another step may involve circulating heating and/or cooling fluid through the at least one fluid-flow passage in the at least one wall of the housing of the battery paste application hopper assembly.

Further scope of applicability of the present disclosure will become apparent from the detailed description provided hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 shows an embodiment of a battery paste application machine;

FIG. 2 is an exploded view of an embodiment of a battery paste application hopper assembly with temperature control capabilities; and

FIG. 3 is a sectional view of the battery paste application hopper assembly.

### DETAILED DESCRIPTION

With reference to the figures, an embodiment of a battery paste application hopper assembly (hereafter, “battery paste hopper assembly”) and accompanying method are presented that enable temperature control capabilities of electrochemically-active battery paste material (hereafter, “battery paste material”) held in the battery paste hopper assembly. Unlike previous battery paste hoppers, one or more walls of the battery paste hopper assembly can be actively heated or cooled, as desired, in order to transfer heating or cooling to the battery paste material. Enhanced rheological properties of the battery paste material are therefore effected. Greater uniformity, consistency, and flowability of the battery paste material can be maintained while held in the battery paste hopper assembly with use of the temperature control capabilities described herein. Moreover, the battery paste hopper assembly more readily precludes unwanted rheological property drift of the battery paste material, localized and bulk temperature changes in the battery paste material, as well as water evaporation from the battery paste material, among other potential improvements. Improved battery paste material density and pasting tolerances can be had with use of the temperature control capabilities herein. Overall, a more effective and efficient battery paste material application process is furnished and, ultimately, a higher quality pasted plate and lead-acid battery end product.

The battery paste hopper assembly can be employed in a larger manufacturing setup and process that produces lead-acid batteries for automotive applications, aeronautic applications, marine applications, consumer equipment applications, small engine applications, and industrial applications, among many other possibilities. As used herein, the terms upstream and downstream refer to directions with respect to the general and intended aggregate movement of battery paste material within the battery paste hopper assembly during use. Still, a particular embodiment of the battery paste hopper assembly may exhibit only one, or a combination of, the advancements set forth herein, none of the advancements, or other advancements not mentioned.

In general, the battery paste hopper assembly is equipped in a battery paste machine. The battery paste machine receives a strip of grids and applies battery paste material to the strip of grids, or can receive a single and individual cast grid and applies battery paste material to it. Applying battery paste material is but one step in the larger manufacturing setup and process. After pasting, in the example of the strip of grids, the pasted strip of grids is ordinarily led to a severing procedure in which the pasted strip of grids is cut into individual pasted grids, and then to a flash drying process to remove moisture from the applied battery paste, among other possible steps in the larger manufacturing setup and process; still, preceding and succeeding process steps may vary. Individual grids are typically composed of a lead or lead alloy metal, and designed with a peripheral frame and crisscrossing wires interconnecting at nodes with open spaces among the wires for receipt of battery paste material.

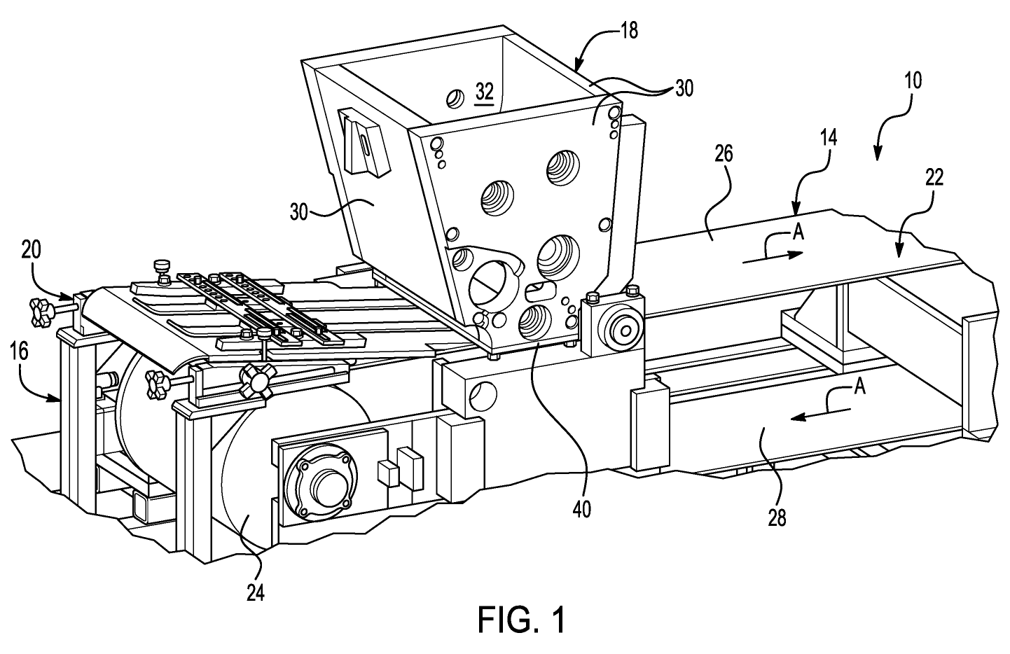

An example embodiment of a battery paste machine 10 is depicted in FIG. 1. Still, other battery paste machines could have other designs, constructions, and components than those shown and described herein, including other types of steel belt pasters, cloth belt pasters, fixed orifice pasters, and drum pasters. In operation of the battery paste machine 10 of FIG. 1, an associated strip of grids is conveyed on an endless belt 14 under a paste hopper 18. The belt 14 carries the strip of grids from an entry end 20 to an exit end 22 of the battery paste machine 10. One or more rollers 24 can be driven by an actuator such as an electric motor. The roller(s) 24 drive movement of the belt 14 and help keep the belt 14 taut. The arrows A in the figure represent movement of the belt 14 along an upper run 26 and a lower run 28 of the belt 14. Different types of belts can be used including stainless steel belts, plastic belts, felt belts, and rubber belts, as well as other kinds of belts. A frame 16 furnishes a structural skeleton of the battery paste machine 10, and can be made-up of a multitude of vertical, side, and cross members of steel joined together. The paste hopper 18 is situated vertically above the upper run 26. The paste hopper 18 has four walls 30 that define an interior 32 in which battery paste material is received and contained prior to its dispensation. The paste hopper 18 has an open top for replenishment of battery paste material during use of the battery paste machine 10. An orifice plate 40 has an orifice through which the battery paste material is dispensed to the strip of grids, according to this example, but other dispensation constructions are possible in other examples such as those that lack orifice plates and instead include pasting shoes. To keep the battery paste material in a somewhat mixed state, the paste hopper 18 can have multiple feed rollers and paddles (not shown; collectively known as battery paste material interior movement inducers) disposed at its interior 32 and driven to rotate by an actuator such as an electric motor.

In some past battery paste machines, it has been observed that temperature changes can occur in the battery paste material contained in the associated paste hopper, and before the battery paste material is dispensed. The temperature changes are unwanted. Bulk temperature of the battery paste material can steadily decrease over time due to ambient condition exposure such as via the open top of the paste hopper. And localized temperature increases can take place near and around the associated rollers and paddles and orifices (or other dispensation structures and/or components) due to friction generated by shearing forces, creating so-called hot spots in the battery paste material. The temperature instabilities and inconsistencies have been shown to adversely effect rheological properties of the battery paste material. Water can more readily evaporate from the battery paste material than desired, and battery paste material density can shift to undesirable values, among other potential shortcomings that could arise. Operators of past battery paste machines would attempt to counter such shortcomings by adding indiscriminate amounts of water to the battery paste material as it sat in the paste hopper. A water sprayer would sometimes be used for this purpose. But such actions are without the proper controls necessary to ensure appropriate rheological properties and to ensure an effective and efficient battery paste material application process.

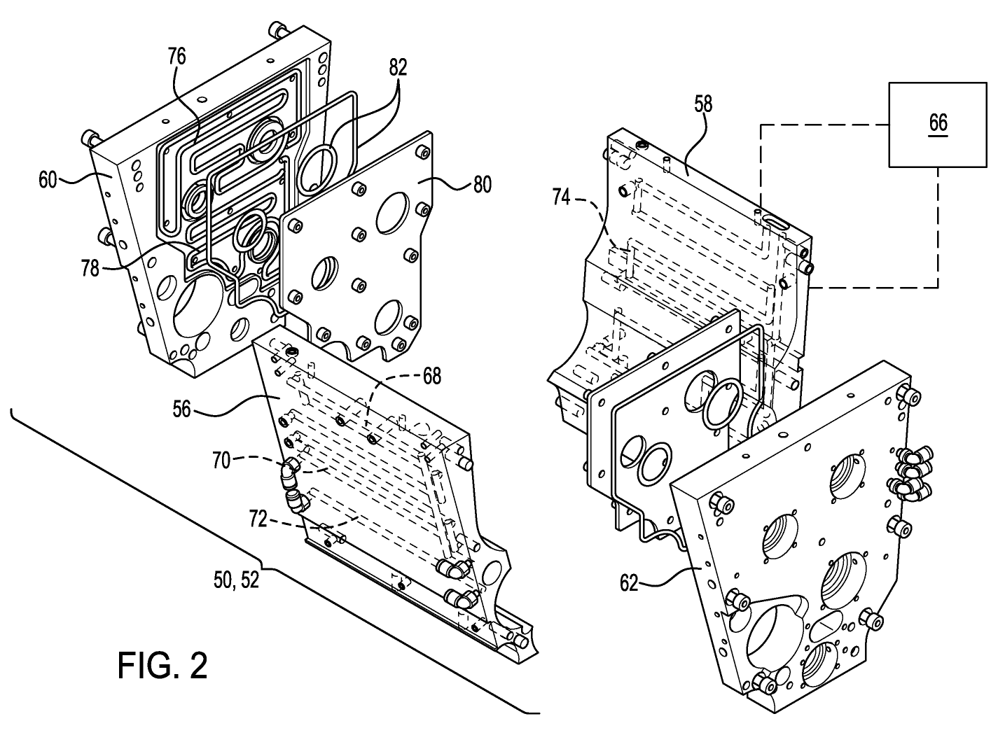

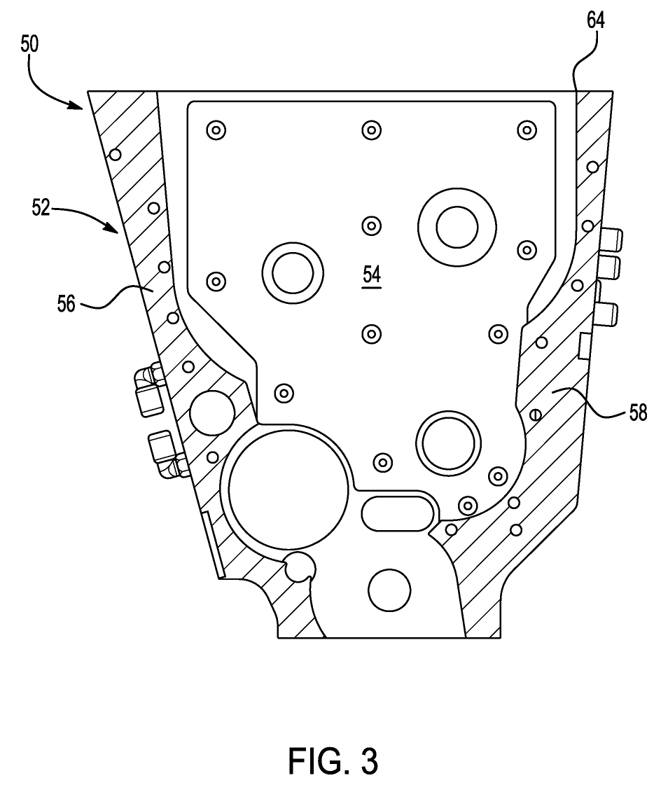

With reference now to FIGS. 2 and 3, an embodiment of a battery paste hopper assembly 50 is presented that has been designed and constructed to resolve the shortcomings set forth above and observed in past battery paste machines. The battery paste hopper assembly 50 is equipped with temperature control capabilities for heating and/or cooling of the battery paste material held and contained therein. The unwanted temperature changes previously observed can be more readily regulated and controlled. Enhanced rheological properties of the battery paste material are therefore more readily effected, as well as greater uniformity, greater consistency, and greater flowability of the battery paste material ultimately dispensed and applied to the underlying strip of grids. A higher quality pasted plate and lead-acid battery end product are hence produced. The temperature control capabilities can have various designs, constructions, and components in various embodiments, depending at least in part upon the design and construction and components of the associated battery paste hopper in which its implementation is carried out, among other potential factors.

In the embodiment of FIGS. 2 and 3, the temperature control capabilities are partly incorporated into the structural components of the battery paste hopper assembly 50 itself, and in particular are incorporated into walls of the battery paste hopper assembly 50. In general, heating and/or cooling fluid-flow is circulated through the walls for heating and/or cooling the walls. The heating and/or cooling in the walls is then transferred to the battery paste material contained in the battery paste hopper assembly 50 and in contact with the walls. The temperature control capabilities effect active temperature control in the sense that the temperature of the heating and/or cooling fluid can be operationally set and managed. The battery paste hopper assembly 50 in this embodiment has a housing 52. The housing 52 is made-up of one or more walls that establish and define an interior 54 in which battery paste material is held and contained therein prior to dispensation during use of the accompanying battery paste machine. The one or more walls include: a first or front wall 56, a second or rear wall 58, a third or first side wall 60, and a fourth or second side wall 62.

For the temperature control capabilities, according to this embodiment, one or all or a combination of the first, second, third, and fourth walls 56, 58, 60, 62 have one or more fluid-flow passages residing and established therein. The fluid-flow passages can reside in the first wall 56, in the second wall 58, in the third wall 60, and/or in the fourth wall 62. Moreover, multiple separate and discrete fluid-flow passages can reside in a single wall of one or all or a combination of the first, second, third, and fourth walls 56, 58, 60, 62, according to various embodiments. For example, a first fluid-flow passage, a second fluid-flow passage, or more fluid-flow passages can be located at a first region, second region, or more regions of the first, second, third, and/or fourth walls 56, 58, 60, 62. However many there are, the fluid-flow passages can take various paths and traverse various regions of the accompanying wall. Locating fluid-flow passages at different regions of the relevant wall or walls can be employed for the purpose of targeting known and unwanted temperature variations that can arise in disparate locations and portions of the battery paste material amid use of the accompanying battery paste machine — for example, hotter regions adjacent rollers, paddles, and/or orifices can be targeted with cooled fluid-flow, and cooler regions adjacent an open top 64 of the housing 52 can be targeted with heated fluid-flow. The fluid-flow passages can be formed in various ways in the relevant wall(s) including via machining, drilling, and casting, among other potential formation techniques.

Furthermore, the heating and/or cooling fluid-flow circulated through the first, second, third, and/or fourth walls 56, 58, 60, 62 can be a gas fluid (e.g., air) or can be a liquid fluid (e.g., coolant), according to various embodiments. One or multiple external heating and/or cooling unit 66 (FIG. 2) can be provided with the battery paste hopper assembly 50 and provided in fluid communication with the fluid-flow passage(s) for heating and/or cooling the fluid circulated therethrough. The quantity of external heating and/or cooling units 66 provided in a particular embodiment can be dictated by the particular heating and/cooling needs. The type of external heating and/or cooling unit furnished can depend upon the temperature to be effected in the fluid, the type of fluid employed, as well as other factors. According to various embodiments, the external heating and/or cooling unit 66 can include a chiller unit, air heat exchanger (AHE), oil heat exchanger (OHE), and/or closed circuit system (CCS), among many other possibilities. Further, the temperature control capabilities of the battery paste hopper assembly 50, per an embodiment, can be employed to maintain a temperature of battery paste material at the interior 54 to be between approximately forty degrees Fahrenheit and approximately ninety degrees Fahrenheit, i.e., 40° F. – 90° F., or between approximately fifty degrees Fahrenheit and approximately eighty degrees Fahrenheit, i.e., 50° F. – 80° F.; still, other ranges of temperature values are possible in other embodiments.

With particular reference to FIG. 2, in this embodiment, a first fluid-flow passage 68, a second fluid-flow passage 70, and a third fluid-flow passage 72 reside in the first wall 56. The first, second, and third fluid-flow passages 68, 70, 72 are separate and discrete fluid-flow passages with respect to one another. Each of the first, second, and third fluid-flow passages 68, 70, 72 has an inlet and an outlet for connection and fluid communication with the external heating and/or cooling unit(s) 66. The first fluid-flow passage 68 spans over and across an upper region of the first wall 56; the second fluid-flow passage 70 spans over and across a middle region of the first wall 56; and the third fluid-flow passage 72 spans over and across a lower region of the first wall 56. The first, second, and third fluid-flow passages 68, 70, 72 can be provided with fluid-flow circulations of temperatures that vary relative to one another for targeting certain temperature variations of the battery paste material at the respective regions — e.g., a fluid-flow circulation exhibiting a first temperature can be provided at the first fluid-flow passage 68, a fluid-flow circulation exhibiting a second temperature can be provided at the second fluid-flow passage 70, and a fluid-flow circulation exhibiting a third temperature can be provided at the third fluid-flow passage 72. The first, second, and third temperatures can differ in value with respect to one another. Further, according to the embodiment of FIG. 2, a fourth fluid-flow passage 74 resides in the second wall 58. As before, the fourth fluid-flow passage 74 has an inlet and an outlet for connection and fluid communication with the external heating and/or cooling unit 66. The fourth fluid-flow passage 74 spans over and across lower, middle, and upper regions of the second wall 58.

Furthermore, according to this embodiment, a fifth fluid-flow passage 76 and a sixth fluid-flow passage 78 reside in the third wall 60. The fifth and sixth fluid-flow passages 76, 78 are separate and discrete fluid-flow passages with respect to one another. Each of the fifth and sixth fluid-flow passages 76, 78 has an inlet and an outlet for connection and fluid communication with the external heating and/or cooling unit(s) 66. The fifth fluid-flow passage 76 spans over and across an upper and middle region of the third wall 60, and the sixth fluid-flow passage 78 spans over and across a lower and middle region of the third wall 60. A section of the sixth fluid-flow passage 78, per this embodiment, partly or more circumscribes a circumference and/or boundary of a roller opening (e.g., feed roller opening; also generally referred to as battery paste material interior movement inducer openings and generally denoted by reference numeral 79 in FIG. 2) defined in the third wall 60; the section can be used for cooling an otherwise hotter region of battery paste material adjacent this roller opening. The fifth and sixth fluid-flow passages 76, 78 can be provided with fluid-flow circulations of temperatures that vary relative to each other for targeting certain temperature variations of the battery paste material at the respective regions — e.g., a fluid-flow circulation exhibiting a first temperature can be provided at the fifth fluid-flow passage 76 and a fluid-flow circulation exhibiting a second temperature can be provided at the sixth fluid-flow passage 78. In this embodiment, the fifth and sixth fluid-flow passages 76, 78 are formed at an internal cavity established on an interior side of the third wall 60. A cover plate 80 can be bolted in place over the internal cavity, and one or more seals 82 can be disposed near boundaries between the cover plate 80 and internal cavity. The cover plate 80 encloses the fifth and sixth fluid-flow passages 76, 78 from the battery paste material held at the interior 54. Lastly, according to this embodiment, a similar construction of fluid-flow passages and cover plate and seals is furnished at the fourth wall 62. Furthermore, an electronic control unit (ECU) can be provided in order to manage the temperatures of the heating and/or cooling fluid flow in the various fluid-flow passages and/or to ultimately manage the temperature of the battery paste material. The ECU can electrically communicate with the external heating and/or cooling unit 66 and can electrically communicate with one or more temperature sensors situated to sense the temperature of the battery paste material at the interior 54.

In general, while a multitude of embodiments have been depicted and described with a multitude of components and steps in each embodiment, in alternative embodiments the components and steps of various embodiments could be intermixed, combined, and/or exchanged for one another. In other words, components and/or steps described in connection with a particular embodiment are not necessarily exclusive to that particular embodiment.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

1. A battery paste application hopper assembly, comprising:
a housing having at least one wall that at least partly establishes an interior for holding electrochemically-active battery paste material therein amid use of the battery paste application hopper assembly, wherein at least one fluid-flow passage resides in said at least one wall, a heating and/or cooling fluid circulates through said at least one fluid-flow passage amid use of the battery paste application hopper assembly.

2. The battery paste application hopper assembly as set forth in claim 1, wherein said at least one wall includes a first wall, a second wall, a third wall, and a fourth wall, and said at least one fluid-flow passage includes a first fluid-flow passage residing in said first wall, a second fluid-flow passage residing in said second wall, a third fluid-flow passage residing in said third wall, and a fourth fluid-flow passage residing in said fourth wall.

3. The battery paste application hopper assembly as set forth in claim 1, further comprising an external heating and/or cooling unit in fluid communication with said at least one fluid-flow passage in order to circulate said heating and/or cooling fluid through said at least one fluid-flow passage.

4. The battery paste application hopper assembly as set forth in claim 3, wherein said heating and/or cooling fluid circulating through said at least one fluid-flow passage via said external heating and/or cooling unit maintains a temperature of the electrochemically-active battery paste material held in said housing between approximately forty degrees Fahrenheit (40°F) and ninety degrees Fahrenheit (90°F).

5. The battery paste application hopper assembly as set forth in claim 1, wherein said at least one wall includes a first wall, and said at least one fluid-flow passage includes a first fluid-flow passage residing in said first wall and a second fluid-flow passage residing in said first wall, said first and second fluid-flow passages being discrete with respect to each other, said first fluid-flow passage residing at a first region of said first wall and said second fluid-flow passage residing at a second region of said first wall, a first heating and/or cooling fluid circulating through said first fluid-flow passage and a second heating and/or cooling fluid circulating through said second fluid-flow passage, said first heating and/or cooling fluid exhibiting a first temperature and said second heating and/or cooling fluid exhibiting a second temperature, said first temperature and said second temperature differing with respect to each other.

6. The battery paste application hopper assembly as set forth in claim 5, wherein a battery paste material interior movement inducer opening resides in said first wall at said first region, and said first fluid-flow passage at least partly circumscribes a boundary of said battery paste material interior movement inducer opening.

7. The battery paste application hopper assembly as set forth in claim 6, wherein said first temperature of said first heating and/or cooling fluid circulating through said first fluid-flow passage is less than said second temperature of said second heating and/or cooling fluid circulating through said second fluid-flow passage during use of the battery paste application hopper assembly.

8. The battery paste application hopper assembly as set forth in claim 7, wherein said battery paste material interior movement inducer opening is a feed roller opening of the battery paste application hopper assembly.

9. The battery paste application hopper assembly as set forth in claim 1, further comprising at least one cover plate carried by said at least one wall and enclosing said at least one fluid-flow passage at said at least one wall.

10. A method of temperature control of a battery paste application hopper assembly, the method comprising:
providing at least one fluid-flow passage in at least one wall of a housing of the battery paste application hopper assembly; and
circulating heating and/or cooling fluid through said at least one fluid-flow passage in said at least one wall of said housing of the battery paste application hopper assembly.

11. The method of temperature control as set forth in claim 10, further comprising substantially maintaining a temperature of electrochemically-active battery paste material held in said housing via said circulation of heating and/or cooling fluid that is heated and/or cooled to a temperature between approximately forty degrees Fahrenheit (40°F) and ninety degrees Fahrenheit (90°F).

12. The method of temperature control as set forth in claim 10, wherein said at least one wall includes a first wall, and said at least one fluid-flow passage includes a first fluid-flow passage residing in said first wall and a second fluid-flow passage residing in said first wall, said first and second fluid-flow passages being discrete with respect to each other, said first fluid-flow passage residing at a first region of said first wall and said second fluid-flow passage residing at a second region of said first wall, and wherein circulating heating and/or cooling fluid through said at least one fluid-flow passage involves circulating a first heating and/or cooling fluid through said first fluid-flow passage and circulating a second heating and/or cooling fluid through said second fluid-flow passage, said first heating and/or cooling fluid exhibiting a first temperature and said second heating and/or cooling fluid exhibiting a second temperature, said first temperature and said second temperature differing with respect to each other.

13. The method of temperature control as set forth in claim 12, wherein a battery paste material interior movement inducer opening resides in said first wall at said first region, and said first fluid-flow passage at least partly circumscribes a boundary of said battery paste material interior movement inducer opening.

14. The method of temperature control as set forth in claim 13, wherein said first temperature of said first heating and/or cooling fluid circulating through said first fluid-flow passage is less than said second temperature of said second heating and/or cooling fluid circulating through said second fluid-flow passage during use of the battery paste application hopper assembly.

15. A battery paste application hopper assembly, comprising:
a housing having a first wall that at least partly establishes an interior for holding electrochemically-active battery paste material therein amid use of the battery paste application hopper assembly, a first fluid-flow passage residing in said first wall and a second fluid-flow passage residing in said first wall, said first and second fluid-flow passages being discrete with respect to each other, said first fluid-flow passage residing at a first region of said first wall and said second fluid-flow passage residing at a second region of said first wall, a first heating and/or cooling fluid circulates through said first fluid-flow passage and a second heating and/or cooling fluid circulates through said second fluid-flow passage during use of the battery paste application hopper assembly, said first heating and/or cooling fluid exhibiting a first temperature and said second heating and/or cooling fluid exhibiting a second temperature, said first temperature and said second temperature differing with respect to each other.
